(19) United States
(12) Patent Application Publication
(10) Pub. No.: US 2015/0112940 A1
(43) Pub. Date: Apr. 23, 2015

(54) SYSTEM, INFORMATION PROCESSING APPARATUS, ACQUISITION METHOD, AND RECORDING MEDIUM

(71) Applicant: FUJITSU LIMITED, Kawasaki-shi (JP)

(72) Inventors: Keiji OZAKI, Akashi (JP); Gensai Hideshima, Nishinomiya (JP); YUKAKO TANIGUCHI, Nishinomiya (JP); Jun Tsunoda, Kobe (JP)

(73) Assignee: FUJITSU LIMITED, Kawasaki-shi (JP)

(21) Appl. No.: 14/579,160

(22) Filed: Dec. 22, 2014

Related U.S. Application Data
(63) Continuation of application No. PCT/JP2012/067133, filed on Jul. 4, 2012.

(51) Int. Cl. G06F 17/30

(52) U.S. Cl. CPC G06F 17/30144
USPC 707/648

(57) ABSTRACT

A system includes a plurality of nodes. Each of the plurality of nodes includes a processor that executes a process. The process includes: storing logs in a memory; requesting another node other than the node in which an abnormality has occurred to send information that indicates order the logs stored in the memory are created; receiving, from the other node, information that indicates order the logs stored in the other node are created; and acquiring, based on the order indicated by the received information and the order the logs stored in the memory are created, when the other node that stores therein a log that is created newer than the logs stored in the memory is present, the log created newer than the logs stored in the memory from the other node that stores therein the log created newer than the logs stored in the memory.

### CROSS-REFERENCE TO RELATED APPLICATION

This application is a continuation application of International Application No. PCT/JP2012/067133 filed on Jul. 4, 2012 and designating the U.S., the entire contents of which are incorporated herein by reference.

### FIELD

The embodiments discussed herein are related to a system, an information processing apparatus, an acquisition method, and an acquisition program.

### BACKGROUND

There are used devices that update, such as change, delete, add, and the like, data in databases by using SQL or the like. Furthermore, there is a system in which two databases are provided and, if one database is updated, the updated data is reflected in the other database (for example, see Japanese Laid-open Patent Publication No. 2007-272648, International Publication Pamphlet No. WO 2008/129620, and Japanese Laid-open Patent Publication No. 2007-58611).

In this system, for example, if a second node that has a database receives an SQL statement from a first node that executes an application that executes a process performed by using SQL, the second node performs the following process. Namely, the second node updates the database based on the SQL statement and creates a log that indicates the updated content of the database. Then, the second node registers the created log in a recovery log file as a recovery log. Furthermore, the second node sends the created log as a difference log to a third node that has another database. The third node that has been received the difference log registers the received difference log in a difference log file and also registers the received difference log in a recovery log file as a recovery log. Then, the third node updates the database by using the recovery log file. Furthermore, the recovery log and the difference log store therein generation numbers that correspond to information indicating the order the logs are created.

Furthermore, in the system described above, for example, when the second node is used as a master node and the third node is used as a slave node, if an abnormality occurs in the second node, the third node is switched to the master node and an application is continued to be executed by the first node.

However, if the related technology described above is used for three or more nodes each of which has a database, there is a problem in that a load is concentrated on a single master node. A description will be given of a case in which the related technology described above is used for three or more nodes each of which has a database. FIGS. 14 and 15 are schematic diagrams each illustrating an example of a case in which a related technology is used for three or more nodes each of which has a database. The system illustrated as an example in FIG. 14 includes an application node 90 and nodes 91a to 91f. In the example illustrated in FIG. 14, the application node 90 executes an application that executes a process performed by using SQL. Furthermore, the example illustrated in FIG. 14 indicates a case in which the node 91a is a master node and the nodes 91b to 91f are slave nodes. Furthermore, in the example illustrated in FIG. 14, each of the nodes 91a to 91f has a database. In the example illustrated in FIG. 14, if the node 91a receives an SQL statement from the application node 90, the node 91a updates the database based on the SQL statement. Then, the node 91a creates a log that indicates updated content of the database. Then, the node 91a registers the created log as a recovery log in a recovery log file. In addition to this, the node 91a sends the created log to the nodes 91b to 91f as a difference log. The nodes 91b to 91f that have received the difference log register the received difference log in a difference log and also register the received difference log as a recovery log in a recovery log file. Then, each of the nodes 91b to 91f updates the database by using the recovery log file.

At this point, if an abnormality occurs in the node 91a that is the master node, for example, as illustrated in FIG. 15, the node 91b is switched to the master node. Here, as indicated by the example illustrated in FIG. 15, the latest generation number of the difference log received by the nodes 91c to 91f, which are slave nodes, are “2”, “5”, “2”, and “4”, respectively. Namely, in the example illustrated in FIG. 15, the nodes 91c to 91f have the difference logs with the generation number of “2”, “5”, “2”, and “4”, respectively. Then, as indicated by the example illustrated in FIG. 15, the node 91b that newly becomes the master node sends a difference log to each of the nodes 91c to 91f such that the generation number of the already received difference log in each of the nodes 91c to 91f becomes the generation number “6” that is the generation number of the difference log stored in the node 91b. In the example illustrated in FIG. 15, the node 91b sends the difference logs with the generation numbers of “3” to “6” to the node 91c. Furthermore, the node 91b sends the difference log with the generation number of “6” to the node 91d. Furthermore, the node 91b sends the difference logs with the generation numbers of “3” to “6” to the node 91e. Furthermore, the node 91b sends the difference logs with the generation numbers of “5” and “6” to the node 91f. In this way, if the related technology described above is used for three or more nodes each of which has a database, the node that is newly switched to the master node sends a large number of difference logs to all of the slave nodes. Consequently, if the related technology described above is used for three or more nodes each of which has a database, there is a problem in that a load is concentrated on the master node.

### SUMMARY

According to an aspect of the embodiments, a system includes a plurality of nodes. Each of the plurality of nodes includes a processor that executes a process. The process includes: storing logs in a memory; requesting another node other than the node in which an abnormality has occurred to send information that indicates order the logs stored in the memory are created; receiving, from the other node, information that indicates order the logs stored in the other node are created; and acquiring, based on the order indicated by the received information and the order the logs stored in the memory are created, when the other node that stores therein a log that is created newer than the logs stored in the memory is present, the log created newer than the logs stored in the memory from the other node that stores therein the log created newer than the logs stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an example of the configuration of a system according to a first embodiment;

FIG. 2 is a schematic diagram illustrating an example of the functional configuration of a node according to the first embodiment;

FIG. 3A is a schematic diagram illustrating an example of a recovery log file;

FIG. 3B is a schematic diagram illustrating an example of a difference log file;

FIG. 4 is a schematic diagram illustrating an example of a process executed by each node;

FIG. 5 is a schematic diagram illustrating an example of a process executed by each node;

FIG. 6 is a schematic diagram illustrating an example of a process executed by each node;

FIG. 7 is a schematic diagram illustrating an example of a process executed by each node;

FIG. 8 is a schematic diagram illustrating an example of a process executed by each node;

FIG. 9 is a schematic diagram illustrating an example of a process executed by each node;

FIG. 10 is a flowchart illustrating the flow of a decision process;

FIG. 11 is a flowchart illustrating the flow of an acquisition process;

FIG. 12 is a flowchart illustrating the flow of a sending process;

FIG. 13 is a schematic diagram illustrating a computer that executes a program;

FIG. 14 is a schematic diagram illustrating an example of a case in which a related technology is used for three or more nodes each of which has a database; and

FIG. 15 is a schematic diagram illustrating an example of a case in which a related technology is used for three or more nodes each of which has a database.

### DESCRIPTION OF EMBODIMENTS

Preferred embodiments will be explained with reference to accompanying drawings. The present invention is not limited to the embodiments.

### [a] First Embodiment

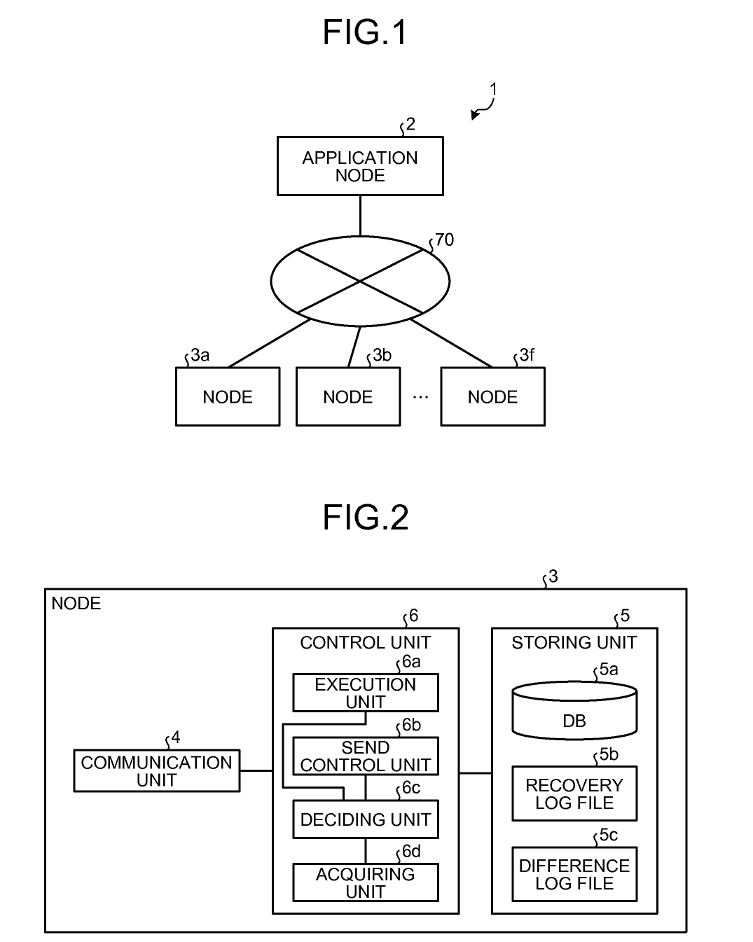

A system according to a first embodiment will be described. FIG. 1 is a schematic diagram illustrating an example of the configuration of the system according to the first embodiment. A system 1 illustrated as an example in FIG. 1 includes an application node 2 and six nodes 3a to 3f. Any number of application nodes and nodes may be used. The application node 2 is connected to the nodes 3a to 3f via a network 70. Namely, the application node 2 and the nodes 3a to 3f can communicate with each other. Furthermore, the application node 2 may be connected to the nodes 3a to 3f via an arbitrary communication network, such as wireless communication, wired communication, or the like. Furthermore, in a description below, when the nodes 3a to 3f are not distinguished, the nodes will be collectively referred to as a node 3. The nodes 3 monitor, with each other, whether an abnormality has occurred. If one of the nodes 3 detects an abnormality of the other one of the nodes 3, the one of the nodes 3 sends information indicating that an abnormality has occurred in the other one of the nodes 3 to both the application node 2 and the nodes 3 in which the abnormality does not occur. Consequently, the application node 2 and the nodes 3 in which the abnormality does not occur can be aware of the node 3 in which the abnormality has occurred.

The application node 2 executes an application that executes a process performed by using SQL. For example, the application node 2 sends an SQL statement to a node that functions as the master node from among the nodes 3a to 3f and then accesses the database stored in the master node.

The node 3 has a database. From among the plurality of nodes 3, if the master node receives an SQL statement from the application node 2, the master node updates the database based on the SQL statement. Then, the master node creates a log that indicates the updated content of the database. Then, the master node registers the created log as a recovery log in a recovery log file. In addition to this, the master node sends the created log as a difference log to a slave node. The slave node that has received the difference log registers the received difference log in a difference log file and also registers the received difference log as a recovery log in a recovery log file. Then, the slave node updates the database by using the recovery log file. Consequently, the content registered in the databases in each of the master node and the slave node matches. However, the content registered in all of the nodes does not possibly match because a communication delay occurs between the master node and the slave nodes and thus an update of a database stored in a slave node is delayed.

FIG. 2 is a schematic diagram illustrating an example of the functional configuration of a node according to the first embodiment. The node 3 includes a communication unit 4, a storing unit 5, and a control unit 6.

The communication unit 4 is an interface for performing communication among the nodes. For example, the communication unit 4 periodically exchanges information indicating that a normal operation is performed with the other nodes 3. If the communication unit 4 does not receive information indicating that the normal operation is performed with the other nodes 3 for a predetermined time period, if the communication unit 4 receives information indicating that an abnormality has occurred, or if the communication unit 4 detects an abnormality of communication, the communication unit 4 sends information to a send control unit 6b, which will be described later, indicating that an abnormality has occurred. Furthermore, if the communication unit 4 receives an SQL statement from the application node 2 via the network 70, the communication unit 4 sends the received SQL statement to the control unit 6. Furthermore, if the communication unit 4 receives a generation number of a recovery log from the send control unit 6b, which will be described later, the communication unit 4 sends the received generation number to a slave node via the network 70. Furthermore, if the communication unit 4 receives information indicating that the node is a master node from a deciding unit 6c, which will be described later, the communication unit 4 sends the received information to the slave node and the application node 2 via the network 70. Furthermore, if the communication unit 4 receives a request for a difference log from an acquiring unit 6d, which will be described later, the communication unit 4 sends the received request to a parent node, which will be described later, via the network 70. Furthermore, if the communication unit 4 receives a completion notification from the acquiring unit 6d, the communication unit 4 sends the received completion notification to the parent node via the network 70. Furthermore, if the communication unit 4 receives a difference log from an execution unit 6a, which will be described later, the communication unit 4 sends the received difference log to the slave node via the network 70.

The storing unit 5 stores therein various kinds of information. For example, the storing unit 5 stores therein a database (DB) 5a, a recovery log file 5b, and a difference log file 5c.

In the DB 5a, data related to a process executed in accordance with a request for the process from the application node 2 is registered by the execution unit 6a, which will be described later. For example, if the own node is the master node, an SQL statement sent from the application node 2 is executed by the execution unit 6a, which will be described later, and consequently, the content registered in the DB 5a is updated. Furthermore, if the own node is the slave node, the content registered in the DB 5a is updated by the execution unit 6a based on the recovery log file 5b.

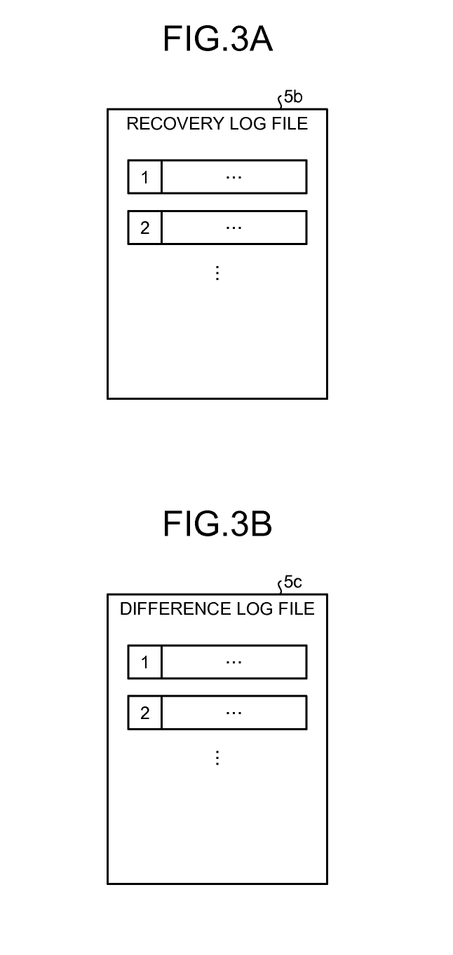

In the recovery log file 5b, if the own node is the master node, a log that is the history of the process executed in accordance with the request for the process from the application node 2 is registered by the execution unit 6a. In this log, a generation number that is information indicating the order the logs are created is included. Furthermore, in the recovery log file 5b, if the own node is the slave node, a difference log that is newly registered in the difference log file 5c is registered as a recovery log by the execution unit 6a. FIG. 3A is a schematic diagram illustrating an example of a recovery log file. The example illustrated in FIG. 3A indicates a case in which logs with the generation numbers of “1”, “2”, and . . . are registered in the recovery log file 5b. The log registered in the recovery log file 5b is also referred to as a “recovery log”.

In the difference log file 5c, if the own node is the slave node, a log sent from the master node is registered by the execution unit 6a. In this log, a generation number that is information indicating the order the logs are created is included. FIG. 3B is a schematic diagram illustrating an example of a difference log file. The example illustrated in FIG. 3B indicates a case in which logs with the generation numbers of “1”, “2”, . . . are registered in the difference log file 5c. The log registered in the difference log file 5c is also referred to as a “difference log”.

The storing unit 5 is, for example, a semiconductor memory device, such as a flash memory, or the like, or is a storage device, such as a hard disk, an optical disk, or the like. However, the storing unit 5 is not limited to the above described type of storage devices but may also be a random access memory (RAM), or a read only memory (ROM).

The control unit 6 includes an internal memory that stores therein control data and programs in which various kinds of procedures are prescribed, whereby various kinds of processes are executed. As illustrated in FIG. 2, the control unit 6 includes the execution unit 6a, the send control unit 6b, the deciding unit 6c, and the acquiring unit 6d.

The execution unit 6a is a processing unit in which software of a relational database management system (RDBMS) is installed. For example, if the own node is the master node, the execution unit 6a performs the following process. Namely, when the execution unit 6a receives an SQL statement from the application node 2, the execution unit 6a executes the received SQL statement and updates the DB 5a. Then, the execution unit 6a creates a generation number and creates a log that includes therein information indicating the created generation number and the executed SQL statement. Subsequently, the execution unit 6a registers the created log as a recovery log in the recovery log file 5b. Then, the execution unit 6a sends the created log as a difference log to the slave node. Consequently, the content registered in each DB 5a in the master node and the slave nodes matches. In this way, the execution unit 6a has a mirroring function that matches the content registered in each DB 5a in the master node and the slave nodes. However, the content registered in all of the nodes does not possibly match because a communication delay occurs between the master node and the slave nodes and thus an update of the database stored in each of the slave nodes is delayed.

Furthermore, if the own node is the master node, the execution unit 6a performs the following process. Namely, if the execution unit 6a receives a completion notification, which will be described later, from a child node with respect to the own node, the execution unit 6a sends, to all of the slave nodes, a difference log with the generation number that has not been stored in the slave nodes.

Furthermore, if the own node is the slave node, the execution unit 6a performs the following process. Namely, if the execution unit 6a receives a difference log from each of the master node and the other slave nodes, the execution unit 6a registers the received difference logs in the difference log file 5c and also registers the received difference logs as a recovery log in the recovery log file 5b. Then, the execution unit 6a updates the DB 5a by using the recovery log file 5b.

The send control unit 6b performs control such that the information that indicates the order the logs stored in the storing unit 5 are created is to be sent to the other nodes other than the node in which an abnormality occurs. Namely, the send control unit 6b requests the other nodes other than the node in which an abnormality occurs to send the information that indicates the order of the logs stored in the storing unit 5 are created. A description will be given by using a specific example. For example, if the send control unit 6b receives, from the communication unit 4, information indicating that an abnormality occurring in a certain node has been detected, the send control unit 6b performs the following process. Namely, the send control unit 6b sends the latest generation number of the recovery log registered in the recovery log file 5b to the communication unit 4 and thus performs control such that the latest generation number is to be sent to the other nodes 3 in which an abnormality does not occur.

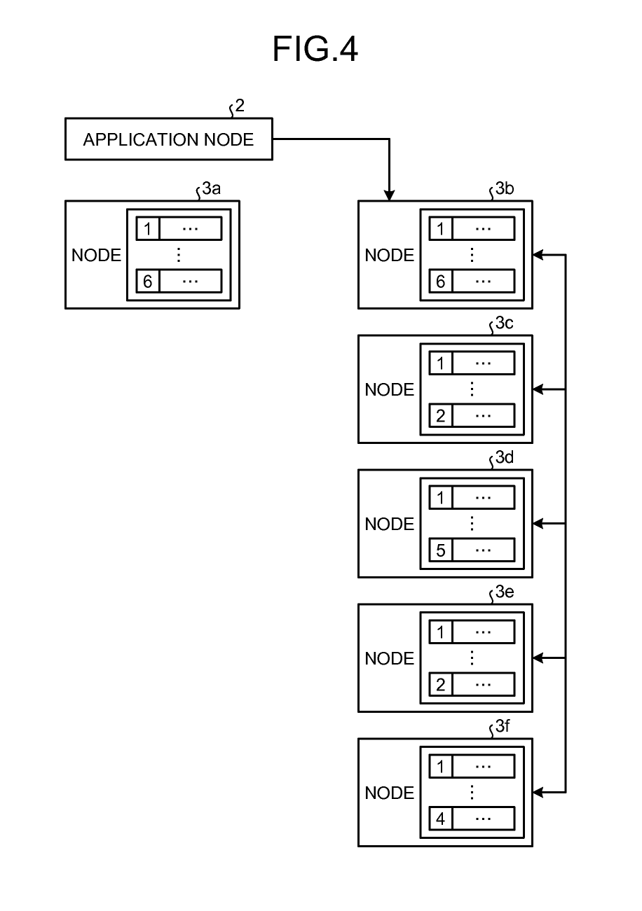

FIG. 4 is a schematic diagram illustrating an example of a process executed by each node. The example illustrated in FIG. 4 indicates a case in which an abnormality occurs in the node 3a when the node 3a is the master node. As indicated by the example illustrated in FIG. 4, the send control unit 6b in the node 3b that has received, from the communication unit 4, the information indicating that an abnormality in the node 3a has been detected, the send control unit 6b controls the communication unit 4 such that the latest generation number “6” of the recovery log is to be sent to the nodes 3b to 3f. Furthermore, as indicated by the example illustrated in FIG. 4, the send control unit 6b in the node 3c that has received, from the communication unit 4, the information indicating that an abnormality in the node 3a has been detected controls the communication unit 4 such that the latest generation number “2” of the recovery log is to be sent to the nodes 3b, 3d, and 3f. Furthermore, as indicated by the example illustrated in FIG. 4, the send control unit 6b in the node 3d that has received, from the communication unit 4, the information indicating that an abnormality in the node 3a has been detected controls the communication unit 4 such that the latest generation number “5” of recovery log is to be sent to the nodes 3a, 3b, 3e, and 3f. Furthermore, as indicated by the example illustrated in FIG. 4, the send control unit 6b in the node 3e that has received, from the communication unit 4, the information indicating that an abnormality in the node 3a has been detected controls the communication unit 4 such that the latest generation number “2” of the recovery log is to be sent to the nodes 3b to 3d, and 3f. Furthermore, as indicated by the example illustrated in FIG. 4, the send control unit 6b in the node 3f that has received, from the communication unit 4, the information indicating that an abnormality in the node 3a has been detected controls the communication unit 4 such that the latest generation number “4” of the recovery log is to be sent to the nodes 3b to 3e.

The deciding unit 6c decides, based on the latest generation number of the recovery log in the own node and the latest generation number of the recovery log in the other node, whether the own node is the master node or the slave node. For example, the deciding unit 6c determines whether the latest generation number of the recovery log has been received from all of the nodes in which an abnormality does not occur. If the latest generation number of the recovery log has been received from all of the nodes, the deciding unit 6c performs the following process. Namely, the deciding unit 6c compares the latest generation number of the recovery log in the own node with the generation numbers that have been received from the other nodes and determines whether the latest generation number of the recovery log in the own node is newer than the generation numbers received from the other nodes.

If it is determined that the latest generation number is the newest, the deciding unit 6c decides that the own node is the master node. Then, the deciding unit 6c decides the other nodes in each of which an abnormality does not occur as the slave nodes. Then, the deciding unit 6c sends information indicating that the own node is the master node to the communication unit 4 and controls the communication unit 4 such that the information is to be sent to the slave nodes and the application node 2. Consequently, the application node 2 that has received the information switches the sending destination of the SQL statement to the new master node. Furthermore, the slave nodes that have received the information can be aware that which node is the master node.

In contrast, if it is determined that the latest generation number is not the newest, the deciding unit 6c decides that the own node is the slave node. If the latest generation number is present in a plurality of nodes, the deciding unit 6c may also perform the following process. For example, the deciding unit 6c compares the media access control addresses (MAC addresses) of the nodes each of which has the latest generation number of the recovery log and then decides the node that has a small MAC address is the master node.

For example, as indicated by the example illustrated in FIG. 4, the deciding unit 6c in the node 3b decides that the node 3b is the master node because the generation number “6” of the recovery log in the node 3b is the latest. Furthermore, the deciding unit 6c in the node 3b decides that the nodes 3c to 3f as the slave nodes. Then, the deciding unit 6c in the node 3b controls the communication unit 4 such that the information indicating that the node 3b is the master node is to be sent to the application node 2 and the slave nodes. Consequently, as indicated by the example illustrated in FIG. 4, the application node 2 switches the sending destination of the SQL statement to the node 3b. Furthermore, as indicated by the example illustrated in FIG. 4, the deciding unit 6c in each of the nodes 3c to 3f decides that the own node is the slave node.

If the own node is the slave node, the acquiring unit 6d performs the following process based on the generation numbers of the recovery logs of the other nodes received by the communication unit 4 and based on the latest generation number of the recovery log that is stored in the own node. Namely, the acquiring unit 6d determines whether there is the other node that stores therein a log with a generation number newer than the latest generation number of the recovery log that is stored in the own node. If the target node is present, the acquiring unit 6d acquires, from the other node that stores therein the log with the new generation number, the log with the generation number newer than the latest generation number of the recovery log stored in the own node.

For example, first, if the own node is the slave node, when the generation number of the latest recovery log stored in the other node is received by the communication unit 4, the acquiring unit 6d performs the following process. Namely, the acquiring unit 6d compares the generation number of the latest recovery log in the other node with the latest generation number of the recovery log in the own node. Then, the acquiring unit 6d determines whether there is the other node that has, as a recovery log with the latest generation number, a recovery log with a generation number newer than the latest generation number of the recovery log in the own node. If there is the other node that has a recovery log with a newer generation number as the recovery log with the latest generation number, the acquiring unit 6d performs the following process. Namely, the acquiring unit 6d decides, as a parent node with respect to the own node from among the other nodes each having the recovery log with the latest generation number, the other node that has, as the latest recovery log, the recovery log with the generation number that is closest to the latest generation number of the recovery log in the own node.

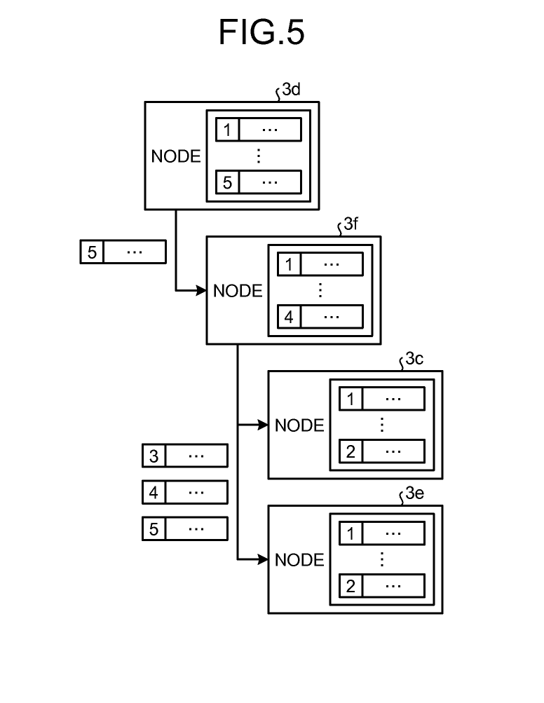

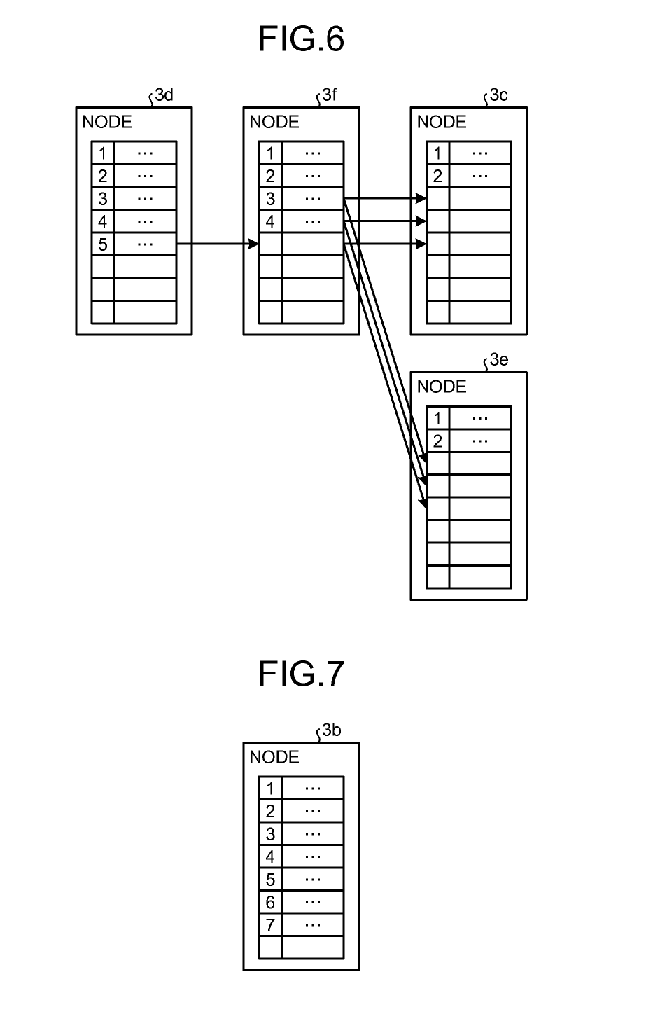

FIGS. 5 and 6 are schematic diagrams each illustrating an example of a process executed by each node. Each of the examples illustrated in FIGS. 5 and 6 indicates a case in which it is determined, in the previous example illustrated in FIG. 4, that the node 3b is the master node and the nodes 3c to 3f are the slave nodes. As indicated by each of the examples illustrated in FIGS. 5 and 6, because the node 3d has, as the recovery log with the latest generation number, the recovery log with the generation number “5” that is newer than the latest generation number “4” of the recovery log in the node 3f, the acquiring unit 6d in the node 3f performs the following process. Namely, the acquiring unit 6d in the node 3f decides, as the parent node with respect to the own node, that the node 3d that has the recovery log with the latest generation number “5” as the latest recovery log. Furthermore, because there are the nodes 3d and 3f that have, as the recovery log with the latest generation number, the recovery logs with the generation numbers “5” and “4”, respectively, which are newer than the latest generation number “2” of the recovery log in the node 3c, the acquiring unit 6d in the node 3c performs the following process. Namely, the acquiring unit 6d in the node 3c decides, as the parent node with respect to the node 3c between the nodes 3d and 3f, the node 3f that has the recovery log with the generation number “4” that is closest to the latest generation number “2” of the recovery log in the node 3c as the latest recovery log. Furthermore, because there are the nodes 3d and 3f that have, as the recovery log with the latest generation number, the recovery logs with the generation numbers “5” and “4”, respectively, which are newer than the latest generation number “2” of the recovery log in the node 3e, the acquiring unit 6d in the node 3e performs the following process. Namely, the acquiring unit 6d in the node 3e decides, as the parent node with respect to the node 3e between the nodes 3d and 3f, the node 3f that has, as the latest recovery log, the recovery log with the generation number “4” that is the closest to the latest generation number “2” of the recovery log in the node 3e.

Then, the acquiring unit 6d compares the generation numbers of the latest recovery logs of the other nodes with the latest generation number of the recovery log in the own node. Then, the acquiring unit 6d determines whether there is the other node that has, as the recovery log with the latest generation number, the recovery log with the generation number older than the latest generation number of the recovery log in the own node. If there is the other node that has the recovery log with old generation number as the recovery log with the latest generation number, the acquiring unit 6d performs the following process. Namely, the acquiring unit 6d decides, as a child node with respect to the own node from among the other nodes having the recovery logs with the old generation numbers, the other node that has, as the latest recovery log, the recovery log with the generation number that is closest to the latest generation number of the recovery log in the own node.

For example, the examples illustrated in FIGS. 5 and 6 indicates a case in which the nodes 3f, 3c, and 3e have, as the recovery log with the latest generation number, the recovery logs with the generation numbers “4”, “2”, and “2” older than the latest generation number “5” of the recovery log in the node 3d. In this case, the acquiring unit 6d in the node 3d decides, as a child node with respect to the node 3d from among the nodes 3f, 3c, and 3e, the node 3f that has, as the latest recovery log, the recovery log with the generation number “4” that is closest to the latest generation number “5” of the recovery log in the node 3d. Furthermore, because nodes 3c and 3e have, as the recovery log with the latest generation number, the recovery log with the generation number “2” older than the latest generation number “4” of the recovery log in the node 3f, the acquiring unit 6d in the node 3f performs the following process. Namely, the acquiring unit 6d in the node 3f decides, as a child node with respect to the node 3f, the nodes 3c and 3e each of which has, as the latest recovery log, the recovery log with the generation number “2” that is closest to the latest generation number “4” of the recovery log in the node 3f.

When the child nodes and the parent node are decided, the acquiring unit 6d determines whether the decided parent node is the master node. If the decided parent node is not the master node, the acquiring unit 6d sends a request to the communication unit 4 to send a difference log with a generation number newer than the latest generation number of the recovery log in the own node and controls the communication unit 4 such that the request is to be sent to the parent node. Consequently, the recovery logs with the generation numbers starting from the generation number, which is newer than the latest generation number of the recovery log in the own node by one, to the latest generation number in the slave node are sent from the parent node to the own node as the difference logs.

For example, as indicated by the examples illustrated in FIGS. 5 and 6, the acquiring unit 6d in the node 3f sends a request to the communication unit 4 to send the difference log with the generation number newer than the generation number “4” and thus controls the communication unit 4 such that the request is to be sent to the node 3d that is the parent node. Consequently, the recovery log of the generation number “5”, which is newer than the latest generation number “4” of the recovery log in the node 3f by one, is sent as a difference log from the node 3d that is the parent node to the node 3f.

If the recovery logs with the generation numbers starting from the generation number, which is newer than the latest generation number of the recovery log in the own node by one, to the latest generation number in the slave node are sent as the difference logs from the parent node or if the parent node is the master node, the acquiring unit 6d performs the following process. Namely, the acquiring unit 6d determines whether completion notifications have been received from all of the child nodes with respect to the own node. If the completion notifications have been received from all of the child nodes, the acquiring unit 6d sends a completion notification to the communication unit 4 and thus controls the communication unit 4 such that the completion notification is to be sent to the parent node.

For example, in the case indicated by the examples illustrated in FIGS. 5 and 6, if the acquiring unit 6d in the node 3f receives a completion notification from each of the nodes 3c and 3e that are the child nodes, the acquiring unit 6d in the node 3f sends the completion notification to the communication unit 4 and thus controls the communication unit 4 such that the completion notification is to be sent to the node 3d that is the parent node. Furthermore, if the acquiring unit 6d in the node 3d receives a completion notification from the node 3f that is the child node, the acquiring unit 6d in the node 3d sends the completion notification to the communication unit 4 and thus controls the communication unit 4 such that the completion notification is to be sent to the node 3b that is the parent node.

In contrast, after determining whether the other node that has the recovery log with old generation number is present, if the determination result indicates that no other node that has the recovery log with old generation number is present, the acquiring unit 6d performs the following process. Namely, the acquiring unit 6d sends a request to the communication unit 4 indicating that the difference log with a generation number newer than the latest generation number of the recovery log in the own node is to be sent and thus controls the communication unit 4 such that the request is to be sent to the parent node. Consequently, the recovery logs with the generation numbers starting from the generation number, which is newer than the latest generation number of the recovery log in the own node by one, to the latest generation number in the slave node are sent as the difference logs from the parent node to the own node.

For example, in the case indicated by the examples illustrated in FIGS. 5 and 6, the acquiring unit 6d in the node 3c sends a request to the communication unit 4 to send the difference logs with the generation numbers newer than the generation number “2” and thus controls the communication unit 4 such that the request is to be sent to the node 3f that is the parent node. Consequently, the recovery logs with the generation numbers starting from the generation number “3”, which is newer than the latest generation number “2” of the recovery log in the node 3c by one, to the latest generation number “5” in the slave node are sent as the difference logs from the node 3f that is the parent node to the node 3c. Similarly, the acquiring unit 6d in the node 3e sends a request to the communication unit 4 to send the difference logs of the generation numbers newer than the generation number “2” and thus controls the communication unit 4 such that the request is to be sent to the node 3f that is the parent node. Consequently, the recovery logs with the generation numbers starting from the generation number “3”, which is newer than the latest generation number “2” of the recovery log in the node 3e by one, to the latest generation number “5” in the slave node are sent as the difference logs from the node 3f that is the parent node to the node 3e.

Then, if the recovery logs with the generation numbers starting from the generation number, which is newer than the latest generation number of the recovery log in the own node by one, to the latest generation number in the slave node are sent as the difference logs from the parent node to the own node, the acquiring unit 6d performs the following process. Namely, the acquiring unit 6d sends a completion notification to the communication unit 4 and thus controls the communication unit 4 such that the completion notification is to be sent to the parent node.

For example, in the case indicated by each of the examples illustrated in FIGS. 5 and 6, the acquiring unit 6d in the node 3c sends the completion notification to the communication unit 4 and thus controls the communication unit 4 such that the completion notification is to be sent to the node 3f that is the parent node. Similarly, the acquiring unit 6d in the node 3e sends the completion notification to the communication unit 4 and thus controls the communication unit 4 such that the completion notification is to be sent to the node 3f that is the parent node.

At this point, as described above, if the own node is the master node, when the execution unit 6a receives a completion notification from the child node with respect to the own node, the execution unit 6a sends, to all of the slave node, the difference logs with the generation numbers that are not stored in the slave nodes.

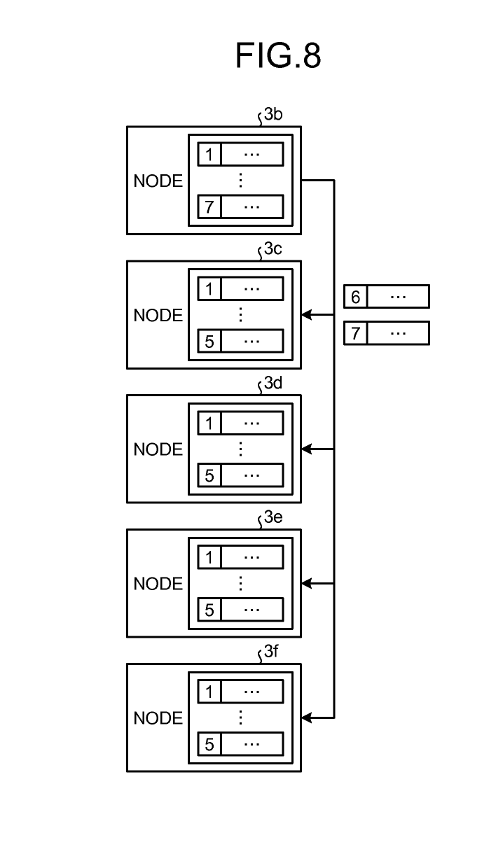

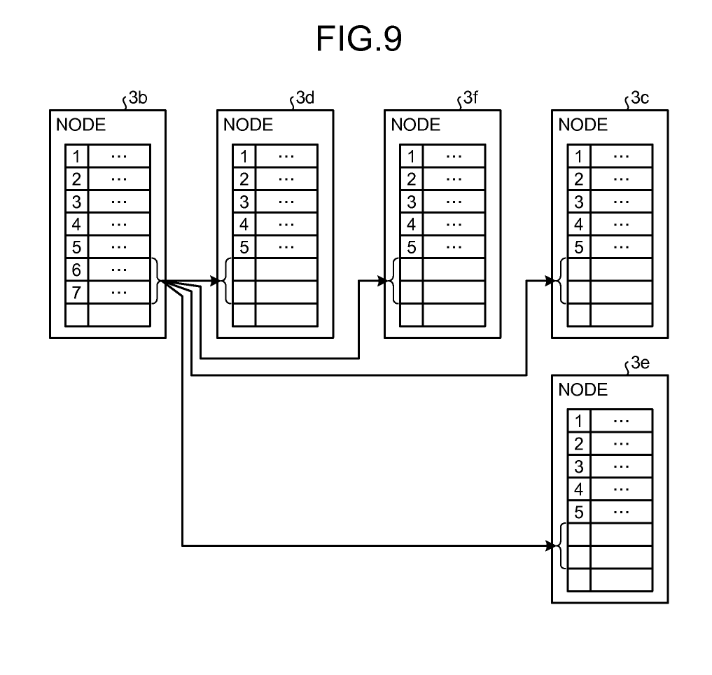

FIGS. 7 to 9 are schematic diagrams each illustrating an example of a process executed by each node. The example illustrated in FIG. 7 indicates a case in which, in the previous example illustrated in FIGS. 5 and 6, an SQL statement is sent from the application node 2 to the node 3b that has been decided to be the master node and the recovery log with the generation number “7” is newly registered in the recovery log file 5b. Furthermore, the example each illustrated in FIGS. 8 and 9 indicates a case in which, in the example illustrated in FIGS. 5 and 6 described above, the latest generation number of the recovery log in each of the nodes 3c to 3f that are the slave nodes becomes the latest generation number “5” in each of the slave nodes.

As indicated by the example each illustrated in FIGS. 7 to 9, the execution unit 6a in the node 3b, i.e., the own node is the master node, performs the following process when the execution unit 6a in the node 3b receives a completion notification from the node 3d that is the child node with respect to the own node. Namely, the execution unit 6a in the node 3b, i.e., the own node is the master node, sends the recovery logs with the generation numbers “6” and “7” that are not stored in the slave nodes to all of the slave nodes (the nodes 3c to 3f) as the difference logs.

In this way, in the system 1 according to the first embodiment, difference logs are sent and received between the parent node and the child nodes of the slave node and then a difference log is sent from the master node to the slave nodes. Thus, in the system 1 according to the first embodiment, it is possible to suppress a load from being concentrated on a single node.

The control unit 6 is an integrated circuit, such as an application specific integrated circuit (ASIC) or the like. Furthermore, the control unit 6 may also be a field programmable gate array (FPGA). Furthermore, the control unit 6 may also be an electronic circuit, such as a central processing unit (CPU) or the like. Furthermore, the control unit 6 may also be a micro processing unit (MPU).

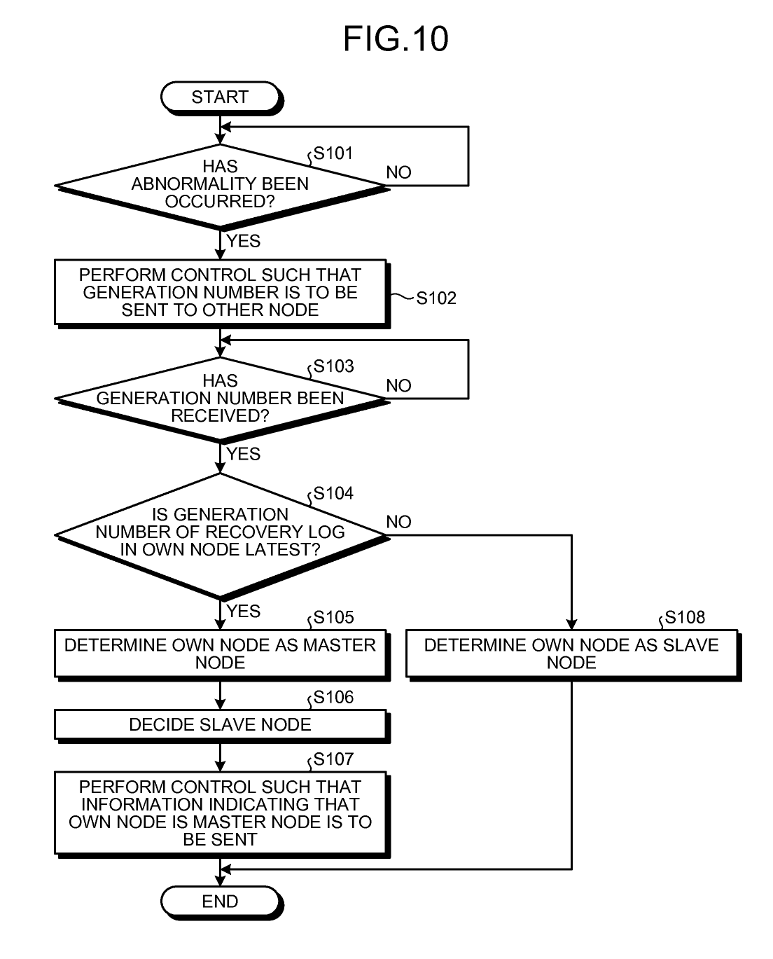

In the following, a description will be given of the flow of a process executed by the node 3 according to the first embodiment. FIG. 10 is a flowchart illustrating the flow of a decision process. This decision process is repeatedly performed at predetermined time intervals during the time period at which, for example, a power supply is turned on the node 3.

As illustrated in FIG. 10, the send control unit 6b determines whether the information indicating that an abnormality has been detected in a node is received from the communication unit 4 described above (Step S101). If the information indicating that an abnormality has been detected in a node is not received (No at Step S101), the send control unit 6b again performs the determination at Step S101. In contrast, if the information indicating that an abnormality has been detected in a node is received (Yes at Step S101), the send control unit 6b performs the following process. Namely, the send control unit 6b sends the latest generation number of the recovery log registered in the recovery log file 5b to the communication unit 4 and performs control such the latest generation number is to be sent to the other node in which an abnormality does not occur (Step S102).

Then, the deciding unit 6c determines whether the latest generation numbers of the recovery logs have been received from all of the other nodes in which an abnormality does not occur (Step S103). If the latest generation numbers of the recovery logs have not been received from all of the other nodes (No at Step S103), the deciding unit 6c again performs the determination at Step S103. In contrast, if the latest generation numbers of the recovery logs have been received from all of the other nodes (Yes at Step S103), the deciding unit 6c performs the following process. Namely, the deciding unit 6c compares the latest generation number of the recovery log in the own node with the generation numbers received from the other nodes and determines whether the latest generation number of the recovery log in the own node is newer than the generation numbers received from the other nodes (Step S104).

If the generation number in the own node is the latest (Yes at Step S104), the deciding unit 6c decides that the own node is the master node (Step S105). Then, the deciding unit 6c decides that the other node in which an abnormality does not occur is the slave node (Step S106). Subsequently, the deciding unit 6c sends the information indicating that the own node is the master node to the communication unit 4, controls the communication unit 4 such that the information is to be sent to the slave node and the application node 2 (Step S107), and then ends the process.

In contrast, if the generation number in the own node is not the latest (No at Step S104), the deciding unit 6c decides that the own node is the slave node (Step S108) and ends the process.

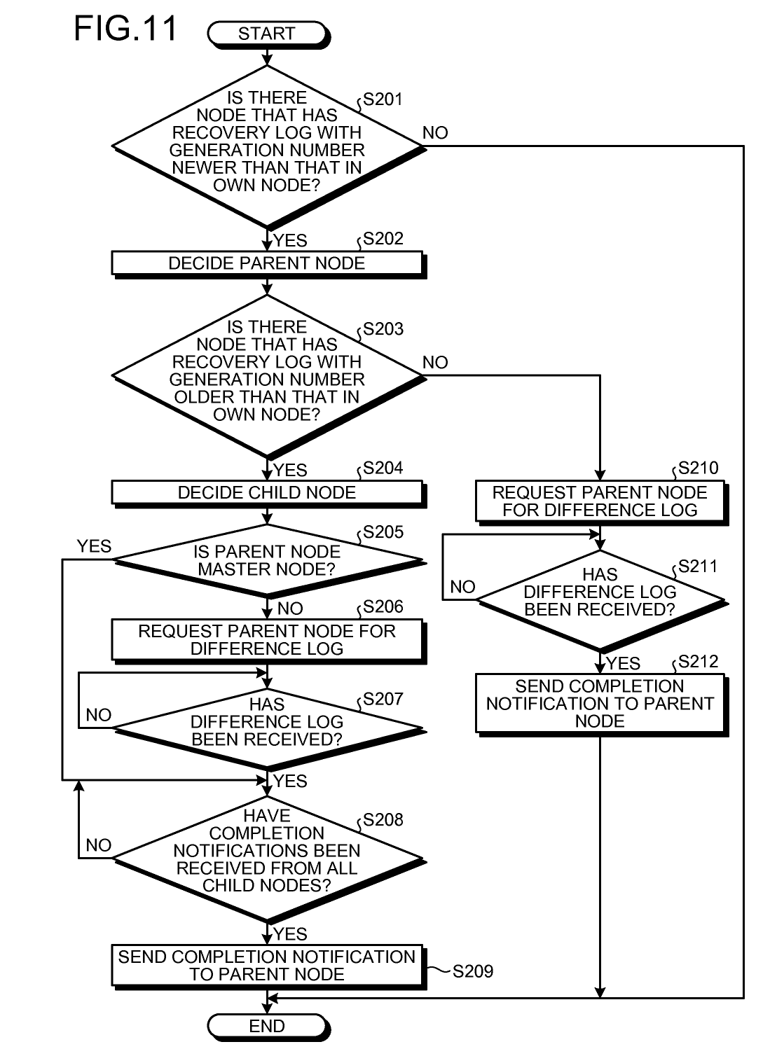

FIG. 11 is a flowchart illustrating the flow of an acquisition process. This acquisition process is performed by, for example, the node that determines that the own node is the slave node by the decision process illustrated in FIG. 10 described above.

As illustrated in FIG. 11, the acquiring unit 6d compares the generation number of the latest recovery log in the other node with the latest generation number of the recovery log in the own node. Then, the acquiring unit 6d determines whether there is the other node that has a recovery log with the generation number newer than the latest generation number of the recovery log in the own node as the recovery log of the latest generation number (Step S201). If there is no other node that has a recovery log with the generation number newer than the latest generation number of the recovery log in the own node as the recovery log of the latest generation number (No at Step S201), the acquiring unit 6d ends the process.

In contrast, if there is the other node that has a recovery log with the generation number newer than the latest generation number of the recovery log in the own node as the recovery log of the latest generation number (Yes at Step S201), the acquiring unit 6d decides, from among the other nodes each of which has a recovery log with a new generation number, that the subsequent node is the parent node with respect to the own node. Namely, the acquiring unit 6d determines that the other node that has, as the latest recovery log, the recovery log with the generation number that is closest to the latest generation number of the recovery log in the own node is the parent node with respect to the own node (Step S202).

Then, the acquiring unit 6d compares the generation number of the latest recovery log in the other node with the latest generation number of the recovery log in the own node. Then, the acquiring unit 6d determines whether there is the other node that has, as the recovery log of the latest generation number, the recovery log of the generation number older than the latest generation number of the recovery log in the own node (Step S203). If there is the other node that has the recovery log with the old generation number as the recovery log of the latest generation number (Yes at Step S203), the acquiring unit 6d performs the following process. Namely, from among the other nodes each of which has a recovery log with the old generation number, the acquiring unit 6d determines that the node that has, as the latest recovery log, the recovery log of the generation number closest to the latest generation number of the recovery log in the own node is the child node with respect to the own node (Step S204).

Subsequently, the acquiring unit 6d determines whether the parent node decided at Step S202 is the master node (Step S205). If the decided parent node is not the master node (No at Step S205), the acquiring unit 6d performs the following process. Namely, the acquiring unit 6d sends a request to the communication unit 4 to send a difference log of the generation number newer than the latest generation number of the recovery log in the own node and thus controls the communication unit 4 such that the request is to be sent to the parent node (Step S206). Then, the acquiring unit 6d determines whether the difference log sent from the parent node has been received (Step S207). If the difference log sent from the parent node has not been received (No at Step S207), the acquiring unit 6d again performs the determination process at Step S207.

In contrast, if the difference log sent from the parent node has been received (Yes at Step S207) or if the parent node is the master node (Yes at Step S205), the acquiring unit 6d performs the following process. Namely, the acquiring unit 6d determines whether completion notifications have been received from all of the child nodes with respect to the own node (Step S208). If the completion notifications have not been received from all of the child nodes (No at Step S208), the acquiring unit 6d again performs the decision process at Step S208.

In contrast, if the completion notifications have been received from all of the child nodes (Yes at Step S208), the acquiring unit 6d sends a completion notification to the communication unit 4, controls the communication unit 4 such that the completion notification is to be sent to the parent node (Step S209), and then ends the process.

Furthermore, if there is no other node that has a recovery log with the old generation number (No at Step S203), the acquiring unit 6d performs the following process. Namely, the acquiring unit 6d sends a request to the communication unit 4 to send a difference log with the generation number newer than the latest generation number of the recovery log in the own node and thus controls the communication unit 4 such that the request is to be sent to the parent node (Step S210).

Then, the acquiring unit 6d determines whether the difference log sent from the parent node has been received (Step S211). If the difference log sent from the parent node has not been received (No at Step S211), the acquiring unit 6d again performs the decision process at Step S211. In contrast, if the difference log sent from the parent node has been received (Yes at Step S211), the acquiring unit 6d performs the following process. Namely, the acquiring unit 6d sends the completion notification to the communication unit 4, controls the communication unit 4 such that the completion notification is to be sent to the parent node (Step S212), and then ends the process.

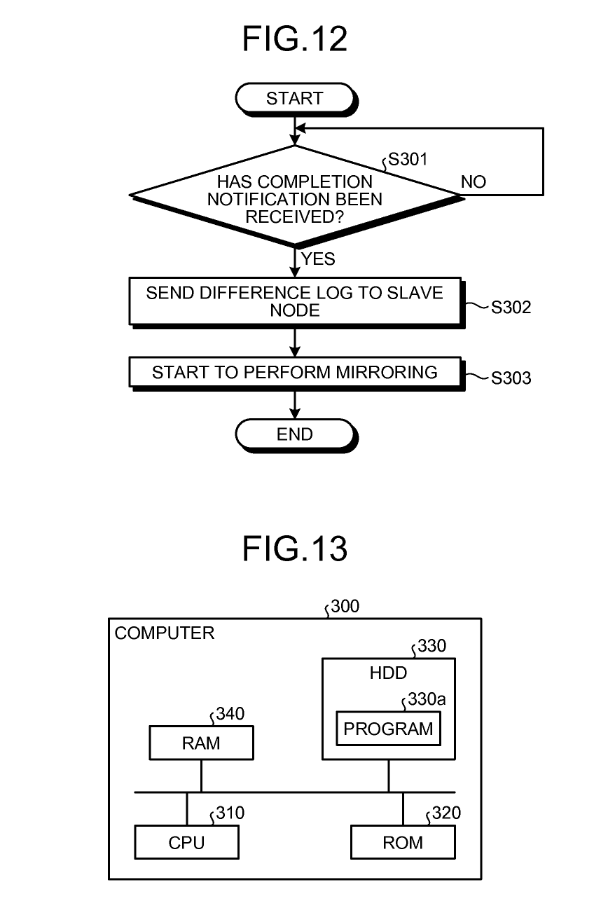

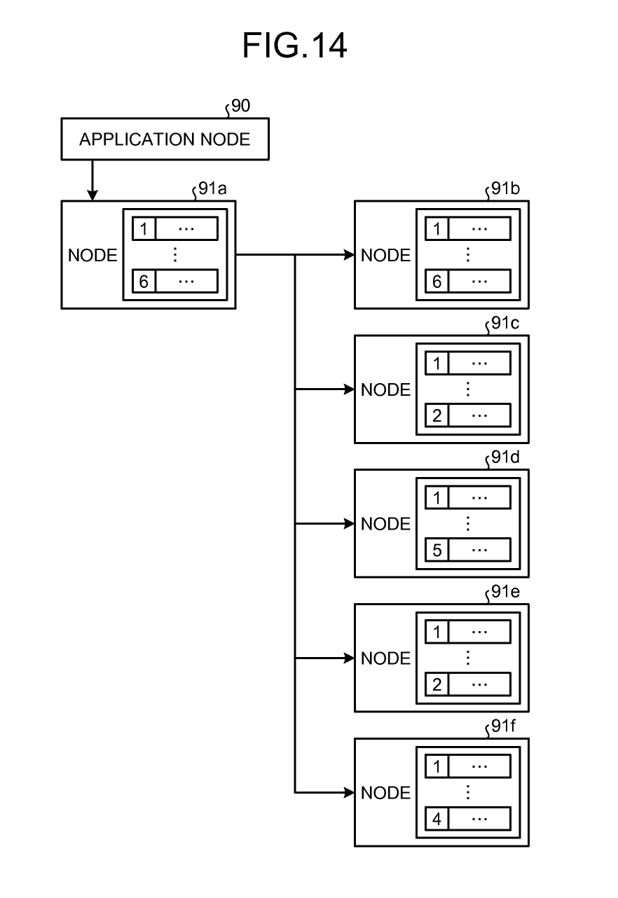

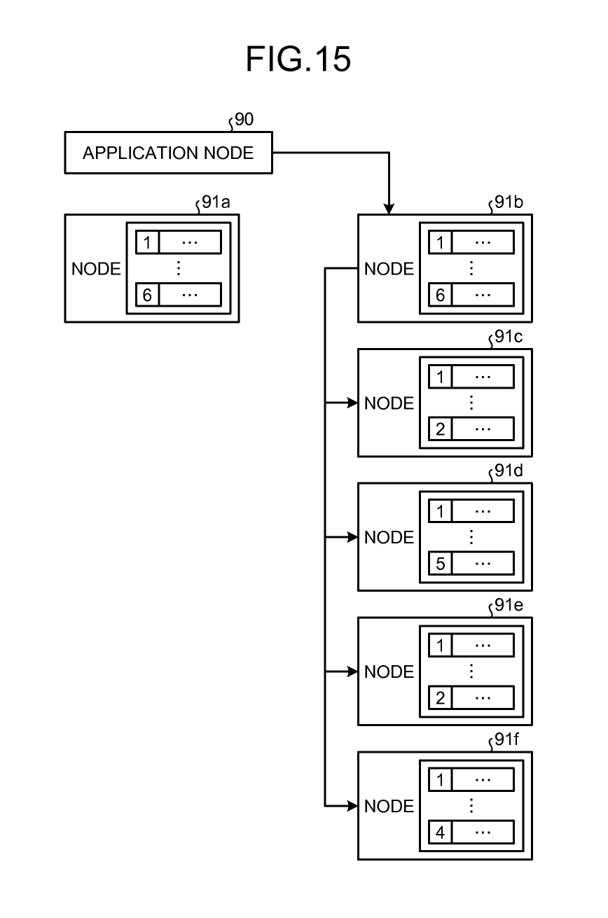

FIG. 12 is a flowchart illustrating the flow of a sending process. This sending process is performed by the node that is decided to be the master node at, for example, the decision process illustrated in FIG. 10 described above.

As illustrated in FIG. 12, the execution unit 6a determines whether a completion notification has been received from the child node with respect to the own node (Step S301). If the completion notification has not been received (No at Step S301), the execution unit 6a again performs the decision process at Step S301. In contrast, if the completion notification has been received (Yes at S301), the execution unit 6a sends, to all of the slave nodes, a difference log with the generation number that has not been received by the slave nodes (Step S302). Then, the execution unit 6a starts to perform mirroring (Step S303) and ends the process.

As described above, in the system 1 according to the embodiment, a difference log is exchanged between the parent node and the child nodes of a slave node and is then sent from the master node to the slave node. Consequently, the system 1 according to the embodiment can suppress a load from being concentrated on a single node.

In the above explanation, a description has been given of the embodiment of the system according to the present invention; however, the present invention can be implemented with various kinds of embodiments other than the embodiment described above. Therefore, another embodiment included in the present invention will be described below.

For example, if a node in which an abnormality is detected is repaired and a state is recovered normally, the same process as that performed by the slave node described in the above embodiment is performed and then the node in which the abnormality is detected may also be included in the system as a slave node.

Furthermore, of the processes described in the embodiment, the whole or a part of the processes that are mentioned as being automatically performed can be manually performed. Furthermore, the whole or a part of the processes that are mentioned as being manually performed can be automatically performed using known methods.

Furthermore, the processes performed at steps described in the embodiment may be separated or integrated depending on various loads or use conditions. Furthermore, it may also possible to omit a step.

Furthermore, the order of the processes performed at steps described in the embodiment may be changed depending on various loads or use conditions.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

[Program]

Furthermore, various processes performed by the node 3 described in the above embodiment can be implemented by program prepared in advance and executed by a computer system, such as a personal computer or a workstation. Accordingly, in the following, an example of a computer that executes a program having the same function as that performed by the node 3 described in the above embodiment will be described with reference to FIG. 13.

As illustrated in FIG. 13, a computer 300 includes a CPU 310, a ROM 320, a hard disk drive (HDD) 330, and a RAM 340. The CPU 310, the ROM 320, the HDD 330, and the RAM 340 are connected by a bus.

The ROM 320 stores therein a basic program, such as an OS or the like. Furthermore, the HDD 330 stores therein, in advance, a program 330a that performs the same function as that performed by the execution unit 6a, the send control unit 6b, the deciding unit 6c, and the acquiring unit 6d described in the embodiment. The program 330a may also be appropriately separated. Furthermore, the HDD 330 includes therein a DB, a recovery log file, and a difference log file. The DB, the recovery log file, and the difference log file correspond to the DB 5a, the recovery log file 5b, and the difference log file 5c, respectively, described above.

Then, the CPU 310 reads the program 330a from the HDD 330 and executes the program 330a.

Then, the CPU 310 reads the DB, the recovery log file, and the difference log file and stores them in the RAM 340. Furthermore, the CPU 310 executes the program 330a by using the DB, the recovery log file, and the difference log file stored in the RAM 340. All the data stored in the RAM 340 does not always have to be stored in the RAM 340, and only a part of data, from among all the pieces of data, used for processes may be stored in the RAM 340.

Furthermore, the program 330a described above does not need to be stored in the HDD 330 from the beginning.

For example, the program is stored in a “portable physical medium”, such as a flexible disk (FD), a CD-ROM, a DVD disk, a magneto-optic disk, an IC CARD, or the like that is to be inserted into the computer 300. Then, the computer 300 may read and execute the program from the portable physical medium.

Furthermore, the program is stored in “another computer (or a server)” or the like that is connected to the computer 300 through a public circuit, the Internet, a LAN, a WAN, or the like. Then, the computer 300 may read the program from the other computer or the server device and execute the program.

According to an aspect of an embodiment of the present invention, an advantage is provided in that a load can be suppressed from being concentrated on a single node.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising a plurality of nodes, wherein
each of the plurality of nodes comprises:
a processor that executes a process including:
storing logs in a memory;
requesting another node other than the node in which an abnormality has occurred to send information that indicates order the logs stored in the memory are created;
receiving, from the other node, information that indicates order the logs stored in the other node are created; and
acquiring, based on the order indicated by the received information and the order the logs stored in the memory are created, when the other node that stores therein a log that is created newer than the logs stored in the memory is present, the log created newer than the logs stored in the memory from the other node that stores therein the log created newer than the logs stored in the memory.

2. The system according to claim 1, wherein the acquiring includes acquiring the log created newer than the logs stored in the memory from the other node that stores therein the log that is created newer than the logs stored in the memory and that includes the closest order to the logs stored in the memory.

3. An information processing apparatus comprising:
a processor that executes a process including:
storing logs in a memory;
requesting another information processing apparatus other than the information processing apparatus in which an abnormality has occurred to send information that indicates order the logs stored in the memory are created;
receiving, from the other information processing apparatus, information that indicates order the logs stored in the other information processing apparatus are created; and
acquiring, based on the order indicated by the received information and the order the logs stored in the memory are created, when the other information processing apparatus that stores therein a log that is created newer than the logs stored in the memory is present, the log created newer than the logs stored in the memory from the other information processing apparatus that stores therein the log created newer than the logs stored in the memory.

4. A non-transitory computer-readable recording medium having stored therein a program that causes a computer to execute an acquisition process comprising:
requesting another information processing apparatus other than an information processing apparatus in which an abnormality has occurred to send information that indicates order logs stored in a memory that stores therein the logs are created; and
acquiring, based on order indicated by information received by the information processing apparatus that receives the information from the other information processing apparatus indicating the order the logs stored in the other information processing apparatus are created and based on the order the logs stored in the memory are created, when the other information processing apparatus that stores therein a log that is created newer than the logs stored in the memory is present, the log created newer than the logs stored in the memory from the other information processing apparatus that stores therein the log created newer than the logs stored in the memory.
